(19) United States
(12) Patent Application Publication
(10) Pub. No.: US 2006/0002688 A1
(43) Pub. Date: Jan. 5, 2006

(54) Bit detection method and device

(75) Inventors: Willem Marie Julia Marcel Coene, Eindhoven (NL); Albert Hendrik Jan Immink, Eindhoven (NL); Johannes Wilhelmus Maria Bergmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/529,689

(22) PCT Filed: Sep. 17, 2003
(86) PCT No.: PCT/IB03/04148

§ 371 Date: Mar. 29, 2005

(30) Foreign Application Priority Data
Oct. 2, 2002 (EP) 02079097.8

(51) Int. Cl. H04N 5/76

(52) U.S. Cl. 386/124

(57) ABSTRACT

The present invention relates to a bit detection method for detecting the bit values of bits of a channel data stream stored on a record carrier, wherein the channel data stream resides on an N-dimensional lattice of bits and comprises a plurality of contiguous bit units, each bit unit comprising at least one bit, wherein bit detection for the channel data stream is performed by an iterative procedure, each iteration being carried out on the basis of said bit units, wherein the bit values of the bits of a bit unit are detected by said iterative procedure based on the received HF signal values of the bits of said bit unit. The proposed method comprises an initialisation step, an updating step and an iteration such the method the bits are detected in an iterative but non-recursive way which allow for a high level of parallel processing in the implementation. In the proposed bit detection method, an evaluation criterion is used which is based on the difference between the received HF-signal and a reference HF-signal for each bit of a bit unit consisting of a plurality of bits, where the reference HF-signal depends on the bit value of the bit to be updated, and on its neighbouring bits, for which bit decisions in a previous iteration step are used. Thus, a high capacity, in particular in two-dimensional optical storage, can be achieved which substantially improves the performance of a threshold detector. Hence, the bit detection method according to the invention does not prohibit implementations aimed for high data-rates.

The present invention relates to a bit detection method for detecting the bit values of bits of a channel data stream stored on a record carrier. Further, the present invention relates to a corresponding bit detector, a method of reproduction of a user data stream, a corresponding reproduction device and a computer program for implementing said methods. In particular, the present invention relates to a bit detection method for information written in a two-dimensional way on a record carrier, such as an optical disc or a memory card.

European patent application 01203878.2 discloses a method and system for multi-dimensionally coding and/or decoding an information to/from a lattice structure representing channel bit positions of said coded information in at least two dimensions. Encoding and/or decoding is performed by using a quasi close-packed lattice structure. For the case of three-dimensional encoding and/or decoding, preferably a (quasi) hexagonally close packed (hcp) lattice structure is to be used. Another possibility in three dimensions is the use of a (quasi) face-centered cubic (fcc) lattice structure. For the case of two-dimensional encoding and/or decoding, preferably a quasi-hexagonal lattice structure is to be used. Another possibility in two dimensions could be the use of a quasi square lattice structure. For the sake of a more simple and clear description of the object of the present invention, special attention is given to the two-dimensional case. The higher-dimensional cases and the one-dimensional case can be derived as more or less straightforward extensions of the two-dimensional case.

In one-dimensional recording on optical discs the channel bits of the channel data stream are recorded along a spiral track, the spiral being one bit wide. For two-dimensional recording the channel bits of a channel data stream can also be recorded along a spiral, albeit a broad spiral, that consists of a number of bit rows which are aligned with respect to each other in the radial direction, that is, in the direction orthogonal to the spiral direction.

It is an object of the present invention to provide a bit detection method that provides a high recording density, in particular such that the traditional “eye” of the eye pattern may even be closed. The “eye height” in the traditional eye-pattern corresponds with the systematic minimum difference in signal levels for the case that a bit has a value “0” and the case that a bit has a value “1”. An “open eye” means that (on average, or without any noise) the signal levels for bit “0” and bit “1” can be clearly discriminated: in such case a threshold detection procedure with an appropriately set slicer level could be used. The case of a “closed eye” corresponds to the situation where some of the signal levels cannot unambiguously be allocated to bit “0” or bit “1”, even in the absence of noise. There is in the latter case a range of signal levels, called the erasure zone, where the signal levels for bit “0” and bit “1” overlap.

It is a further object of the present invention to achieve a low bit error rate, which is particularly less than 10⁻² to 10⁻¹ as would be achieved for the case of a “closed eye” by application of a straight forward threshold detection prior to ECC decoding. Preferably, the symbol or byte error rate (BER) for random errors in the case of a byte-oriented ECC, like the picket-ECC as used in BD (Blu-ray Disc format, formerly known as DVR), shall not be larger than 2×10⁻³; for an uncoded channel bit stream this corresponds to an upper bound on the allowable channel-bit error rate (bER) of 2,5×10⁻⁴.

These objects are achieved according to the present invention by a bit detection method as claimed in claim 1 according to which the channel data stream resides on an N-dimensional lattice of bits and comprises a plurality of contiguous bit units, each bit unit comprising at least one bit, wherein bit detection for the channel data stream is performed by an iterative procedure, each iteration being carried out on the basis of said bit units, wherein the bit values of the bits of said bit units are detected by said iterative procedure based on the received HF signal values of the bits of said bit units, said method comprising:

an initialisation step to obtain preliminary bit decisions for the bits of said bit units based on the HF signal values of said bits,

an updating step to update the bit values of the bits of said bit unit to be updated by searching for the bit values of each of the bits in said bit unit to be updated that best fulfil a predetermined criterion for said bit unit to be updated, said criterion being determined by the differences of the HF signal value and a reference HF signal value for each single bit of said bit unit to be updated, wherein said reference HF signal value is determined by the bit value of said single bit in said bit unit to be updated and by the bit values of the neighbouring bits of said single bit, and

an iteration to iterate said updating step until a predetermined condition is fulfilled.

These objects are further achieved by a bit detector as claimed in claim 17 comprising an appropriate initialisation means, an updating means and an iteration means.

The invention relates further to a method of reproduction of a user data stream, which is error correction code encoded and modulation code encoded into a channel data stream and stored on a record carrier, comprising a bit detection method as described above for detecting the bit values of bits of the channel data stream and a modulation code decoding method and an error correction code decoding method. Still further, the present invention relates to a reproduction device as claimed in claim 21 and a computer program as claimed in claim 22. Preferred embodiments of the invention are defined in the dependent claims.

The present invention is based on the idea to implement the bit detection method in an iterative but non-recursive way which allows for a high level of parallel processing in the implementation. As a reference, the PRML-type (partial-response-maximum-likelihood) of bit detectors sometimes used in 1D storage applications typically operate in a recursive way. Thus, for the non-recursive bit detectors of the present invention, a high capacity, in particular in two-dimensional optical storage, can be achieved which substantially improves the performance of a threshold detector. Hence, the bit detection method according to the invention does not prohibit implementations aimed for high data-rates. Preferably, the bit detection method performs joint bit detection, accounting preferably for the isotropic two-dimensional inter-symbol-interference (ISI), thus both in tangential and radial directions. Further, a low channel-bit error rate level for high densities can be reached as is required for achieving the required reliability of the storage channel, taking also the error correction coding into account.

According to the present invention bit units are formed comprising at least one bit. The bit values of the at least one bit are determined in said iterative procedure. In a first initialisation step preliminary bit decisions are obtained for said bits, for instance by a threshold detection, while in subsequent updating steps said preliminary bit decisions are updated, i.e. based on the detected HF signal values for said at least one bit and one or more reference HF signal values out of a set of reference HF signal values that is kept in memory. One reference HF-signal level is defined for each possible configuration of bits on the two-dimensional lattice of bits, which are denoted as (typical) clusters of bits. A cluster may consist, for instance, of a central bit and a number of neighbouring bits. For a 7-bit cluster, there a 6 nearest neighbouring bits apart from the central bit.

For each single bit of the bit unit the most likely bit values shall be determined using a predetermined evaluation criterion. Said determination is obtained by use of the bit values of the bits of the bit unit itself as well as by use of the bit values of the neighbouring bits of the bit unit. This is advantageous since the neighbouring bits or at least some of the neighbouring bits that are part of neighbouring bit units, have been updated in a previous iteration and are therefore more reliable than the bits of the bit unit itself, and they may further include an information which, in connection with the detected HF signal value, allows a more precise determination of the bit value of the bits of the bit unit. Said iteration is performed until a predetermined condition is met, for instance until a predetermined number of iterations has been performed or until an improvement of the predetermined evaluation criterion that should result in an improvement of the determined bit value has not been achieved during the last iteration(s).

Application of threshold detection will not yield the required low bit-error rates for the high capacity systems that are aimed at with two-dimensional optical storage. Thus, the bit detectors of the present invention will yield a high reliability (with low bit-error rate) for the high capacity systems, and because of their non-recursive character, they also allow to reach a high data rate since the processing can be implemented in a parallel way up to a large extent.

In case, the bit unit whose bit values are to be determined in an updating step comprises more than one bit, all possible bit patterns of said bit unit have to be evaluated. For each of these possible bit patterns, the bit values of said bits are set in accordance to the bit pattern at hand. Thus, each single bit of the bit unit to be updated has its own neighbouring bits whereby some of them can be neighbouring bits for all bits of the bit unit to be updated. Moreover, one or more neighbouring bits of a particular bit can even be another bit of the same bit unit to be updated at the same time. Preferably, the bit values of neighbouring bits which are not part of the bit unit to be updated, are determined in a previous updating step of the iterative procedure, preferably in the proceeding updating step, while the bit values of the neighbouring bits, which are part of the bit unit to be updated, are said to be equal to the corresponding bit values that apply for the current bit-pattern of the bit unit to be updated that is being evaluated.

According to another preferred embodiment the preliminary bit decisions of the initialisation step are obtained by threshold detection using a slicer level. Said threshold detection is based on the detected HF signal value for a particular bit.

Different criteria can be chosen to be fulfilled in said updating step. A preferred embodiment uses a criterion which is determined by the sum over all the bits in the bit unit, said sum comprising the squared differences of the HF signal value and a reference HF signal value of each single bit of the bit unit. Thus, in general 2ⁱ sums, i being the number of bits in the bit unit, are determined, one for each possible bit unit. The bit unit yielding the lowest value for the sum will be selected as the outcome of the current iteration of the bit detection method. Alternatively, said sum comprises the absolute values of the differences of the HF signal value and a reference HF signal value for each single bit of said bit unit.

Generally, the present invention is applicable to a multi-dimensional code, where the channel words of the channel data stream may evolve in a one-dimensional direction of infinite extent for a track-based system, i.e. for an optical record carrier along a spiral track. On the other hand, the channel words of the channel data stream may evolve in more than one direction as is the case for a card-based system. A first preferred application is in 3-dimensional coding where the bits are located on a 3-dimensional lattice of bit positions. However, it is preferred to apply the invention to a channel data stream which comprises a one-dimensionally evolving bit sequence or which comprises a channel strip of at least two bit rows one-dimensionally evolving along a first direction and aligned with each other along a second direction orthogonal to said first direction, said two directions constituting a two-dimensional lattice of bit positions. Preferred embodiments of the latter case are defined in claims 8 to 15.

As already mentioned the bit unit may comprise one ore more bits. In a simple case each bit unit comprises exactly one bit. It is then preferred that the bit value of said single bit is updated by a threshold operation using an adapted slicer level set at half of the sum of a first reference HF-signal level for the case said single bit would have bit value 0 and a second reference HF-signal level for the case said single bit would have bit value 1. Said reference HF-signal levels depend on the bit values of the neighbouring bits. The latter bit values of the neighbouring bits have been determined in a previous iteration. Using in addition the information from the neighbouring bits as opposite to the use of a standard slicer where the slicer level is independent of the neighbouring bits, will then allow to decide with higher reliability if the bit value of the bit of the bit unit to be updated is 0 or 1.

According to further preferred embodiments the bits of the channel data stream are arranged on a two-dimensional hexagonal or a square lattice and each bit unit comprises two or three bits.

The bit detection according to the present invention can be implemented sequential or in parallel. Preferred embodiments using a sequential implementation are defined in claims 13 and 14. Therein threshold detection and updating of bits is preferably performed bit column by bit column within a detection window while in each bit column the bit values are determined according to a “zig-zag” sequence starting from the outermost bits of the bit column and ending at the innermost bit of the bit column. This procedure is continued until it reaches the last bit column of the detection window whereafter the detection window is shifted in the direction in which the code evolves along the spiral track comprising at least two bit rows.

Alternatively the bit values of the bits of an bit unit to be updated can also be updated in parallel for a number of bit columns. Such parallel implementation may be beneficial with respect to obtainable data rate.

According to a preferred embodiment also soft-decision information or reliability information can be obtained from bit detector units of the proposed bit detector, and this soft-decision information may be used in subsequent iterative decoding procedures, for instance like turbo-decoding or LDPC (low-density parity-check) decoding.

A bit detector according to the present invention and preferred embodiments thereof are defined in claims 17 to 19. In the embodiment of claim 19 the bit detector needs N bit-clock instants (clock1) to achieve a next bit-update, which is clocked at an N-times lower clock (clock2) into a subsequent register of a second array for storing bit-vectors.

The invention shall now be explained with reference to the drawings in which

FIG. 1 shows a block diagram of a general layout of a coding system,

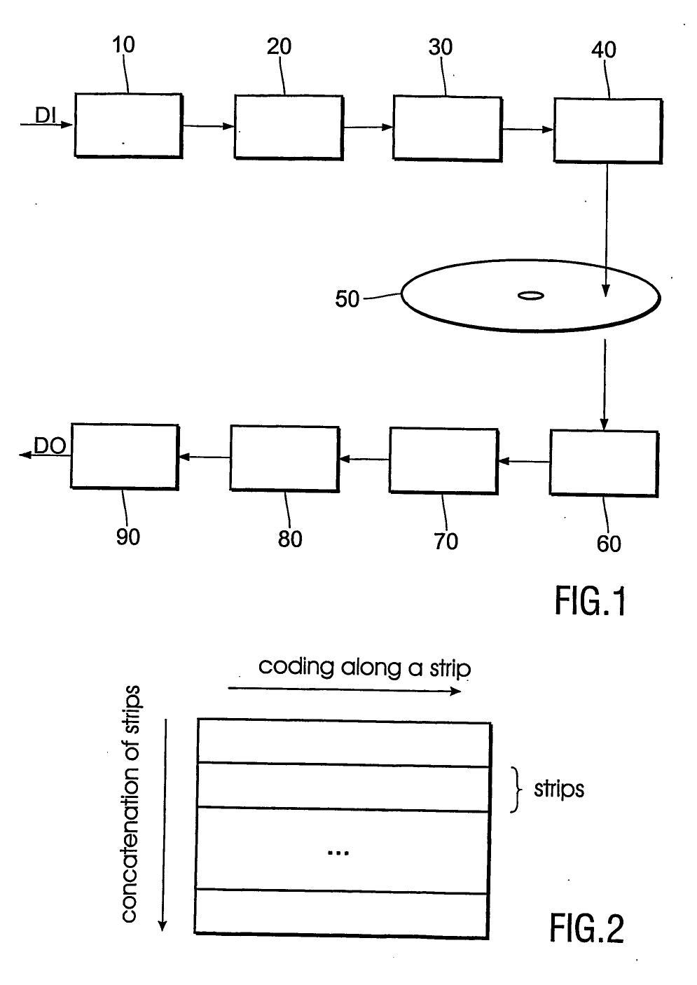

FIG. 2 shows a schematic diagram indicating a strip-based two-dimensional coding scheme,

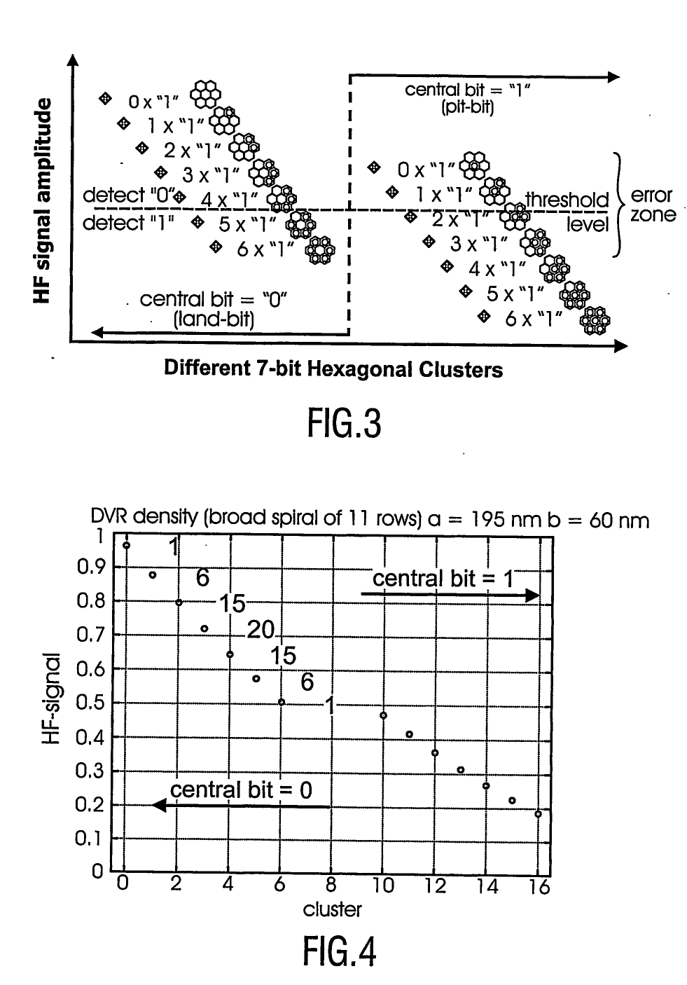

FIG. 3 shows a schematic signal-pattern for a two-dimensional code on hexagonal lattices,

FIG. 4 shows a raw scalar-diffraction signal-pattern for a first density,

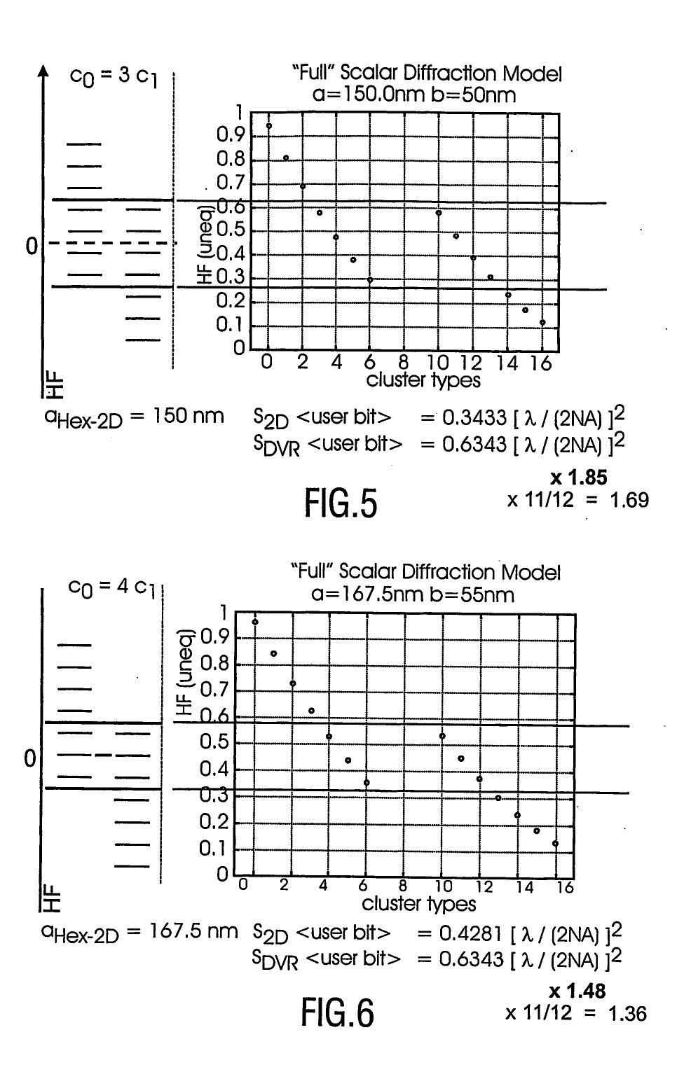

FIG. 5 shows a raw scalar-diffraction signal-pattern for a second density,

FIG. 6 shows a raw scalar-diffraction signal-pattern for a third density,

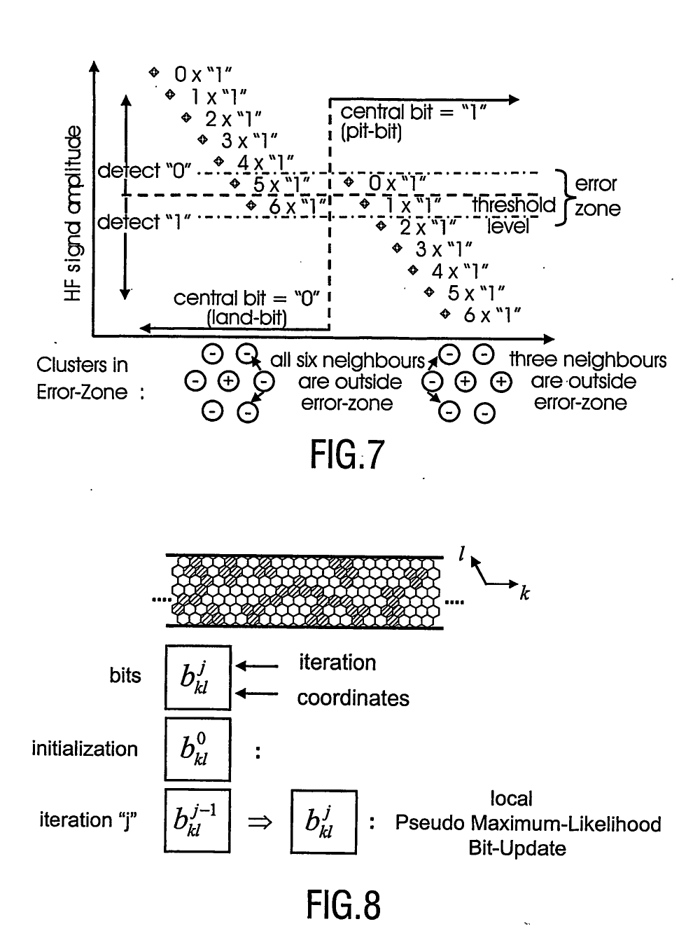

FIG. 7 shows a schematic signal-pattern with two-level overlap in the error zone,

FIG. 8 shows a schematic diagram for an iterative hard-decision bit detector,

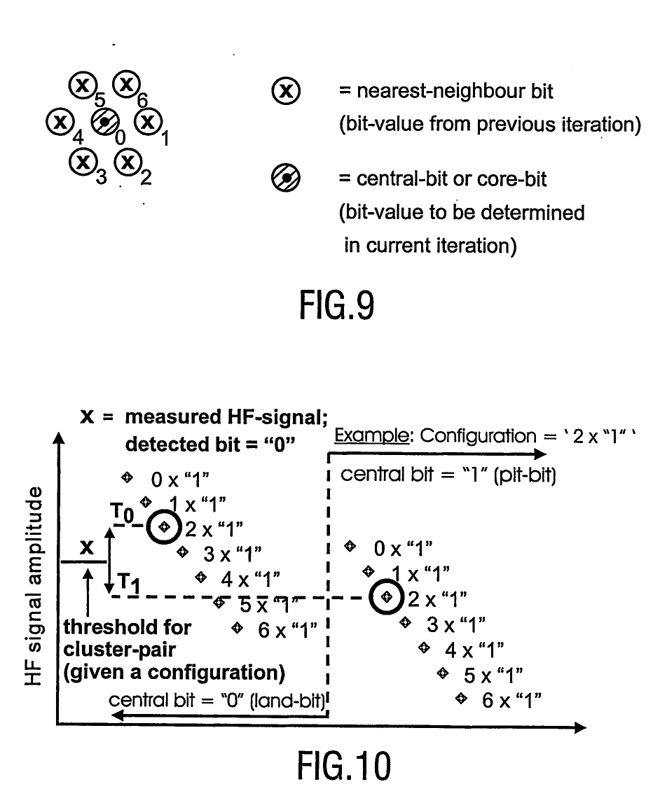

FIG. 9 shows a hexagonal bit-cluster as used for single-bit iterative hard-decision bit detection,

FIG. 10 illustrates nearest neighbour dependent threshold detection,

FIG. 11 shows different bit units comprising one, two or three central bits,

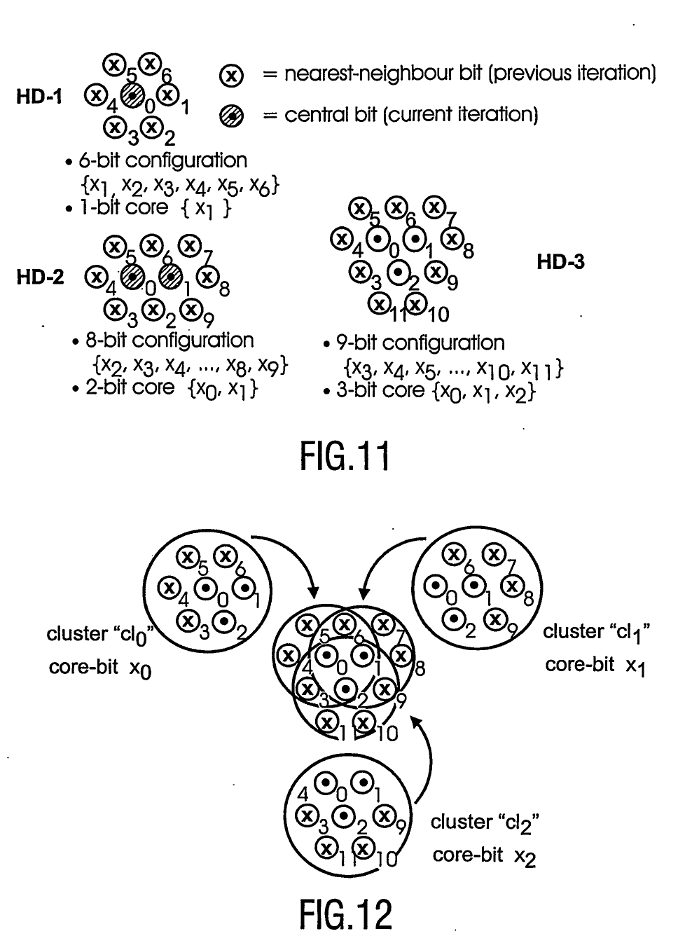

FIG. 12 illustrates the three hexagonal clusters for a bit unit comprising three bits,

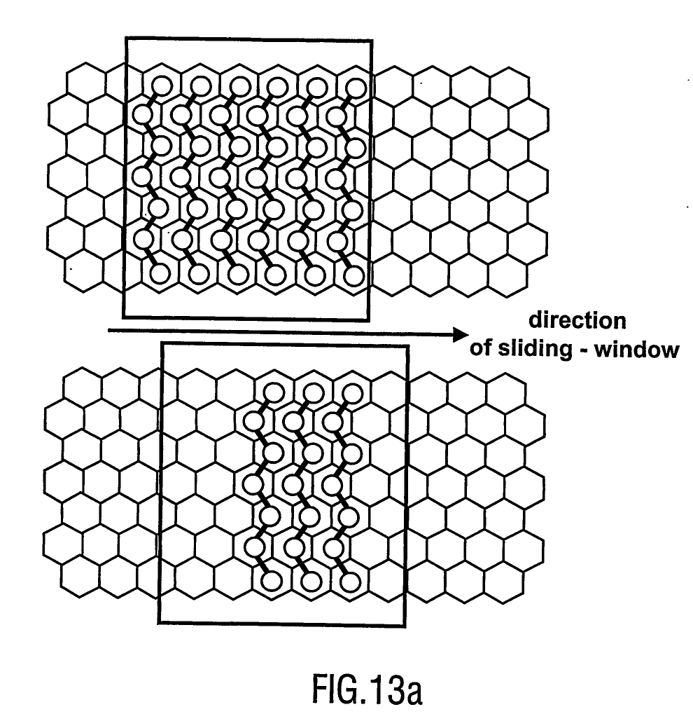

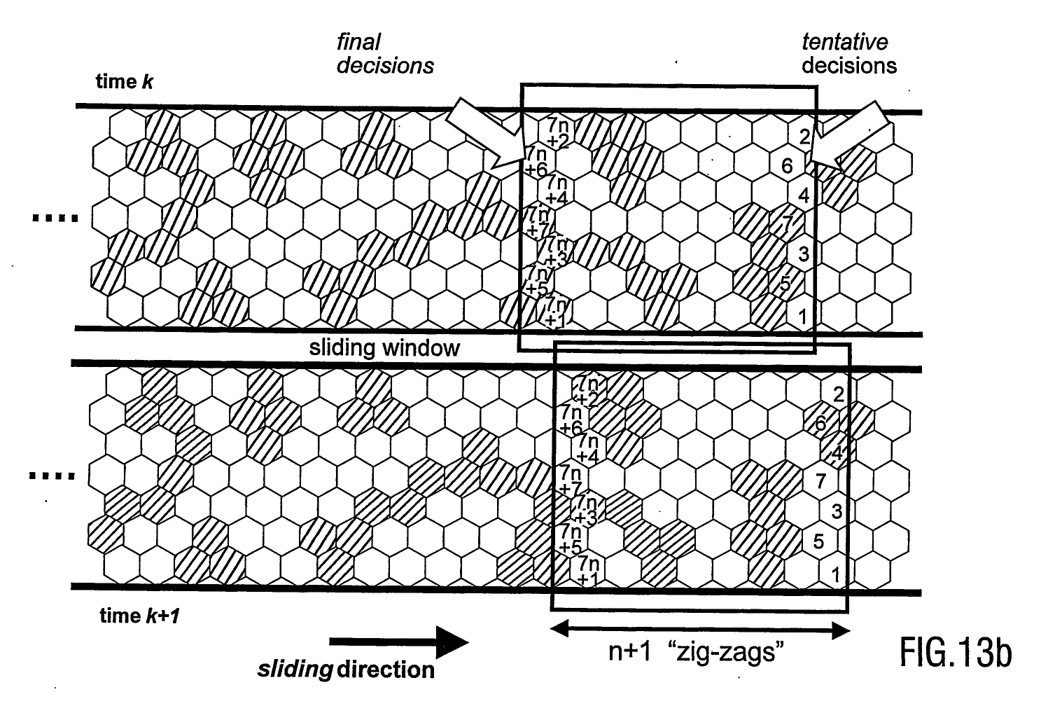

FIG. 13 illustrates the sliding detection window sequential implementation,

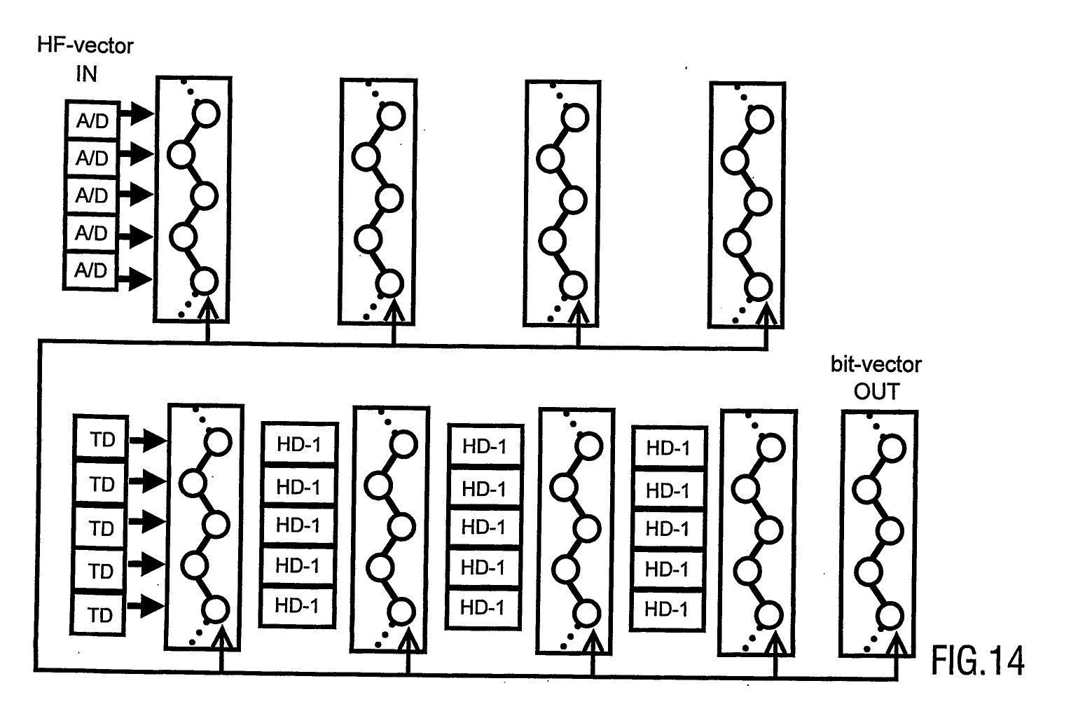

FIG. 14 shows a block diagram of a bit detector in case each bit unit comprises a single bit,

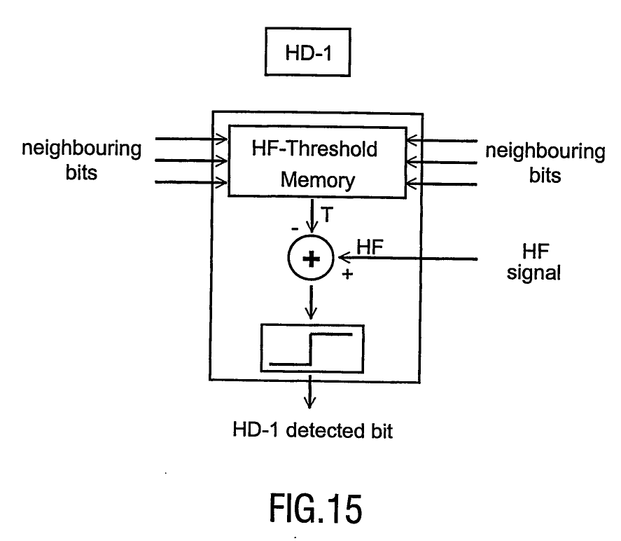

FIG. 15 illustrates a single bit detector unit for a bit detector as shown in FIG. 14,

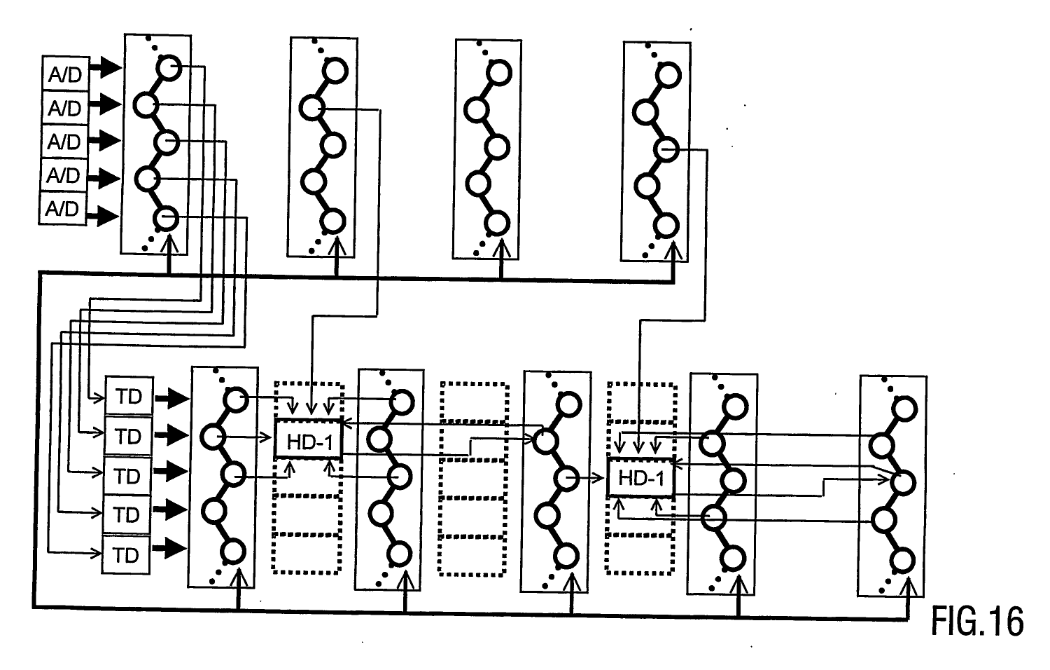

FIG. 16 illustrates bit detection using a bit detector as shown in FIG. 14,

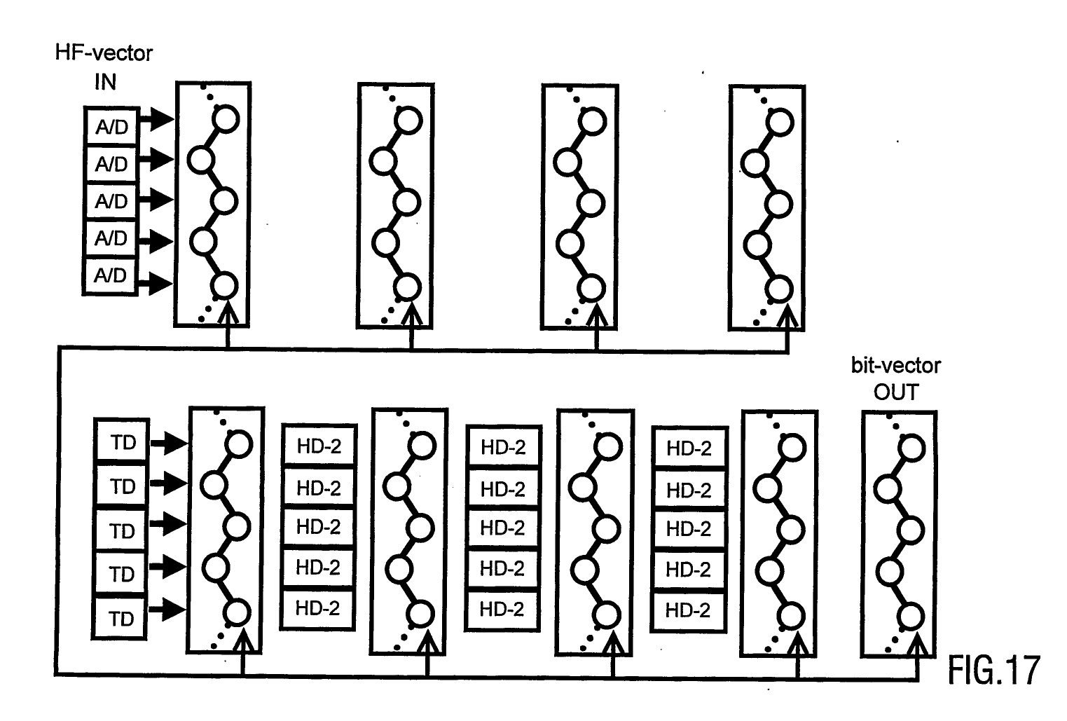

FIG. 17 shows a bit detector in case each bit unit comprises two bits,

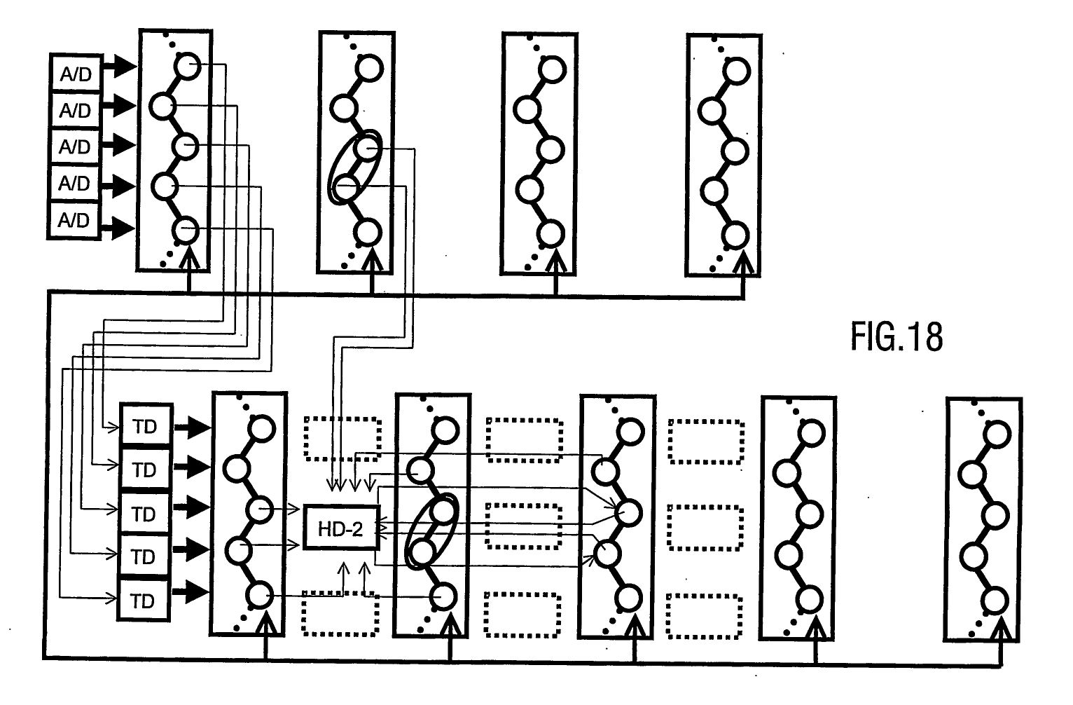

FIG. 18 illustrates bit detection using a bit detector as shown in FIG. 17,

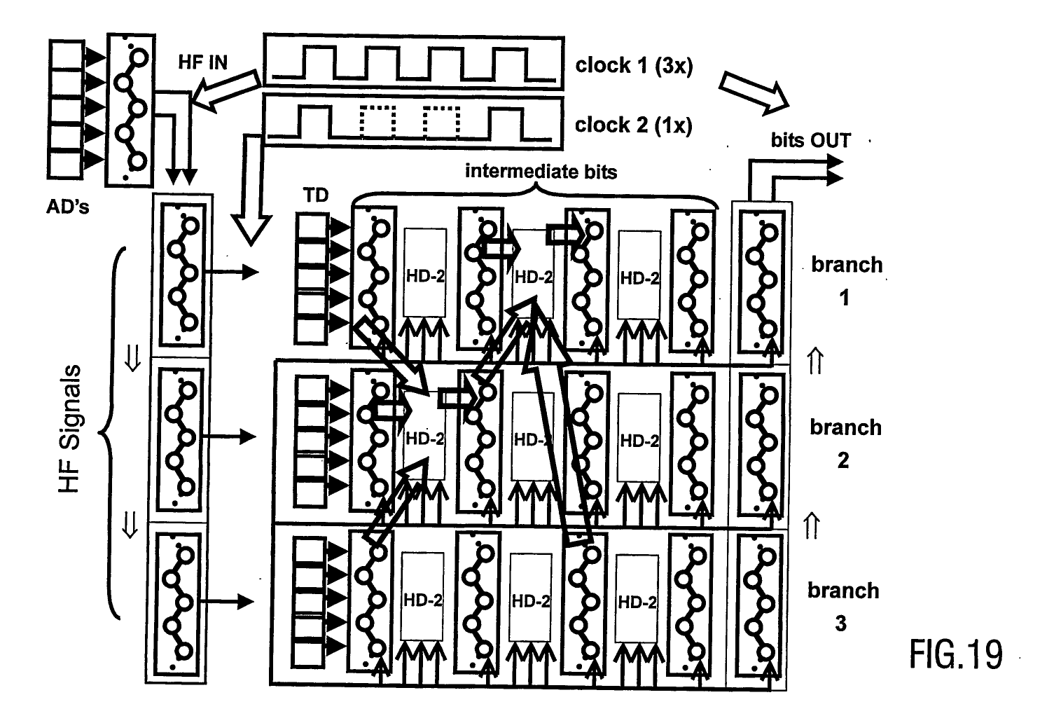

FIG. 19 illustrates a parallel implementation using a bit detector as shown in FIG. 17,

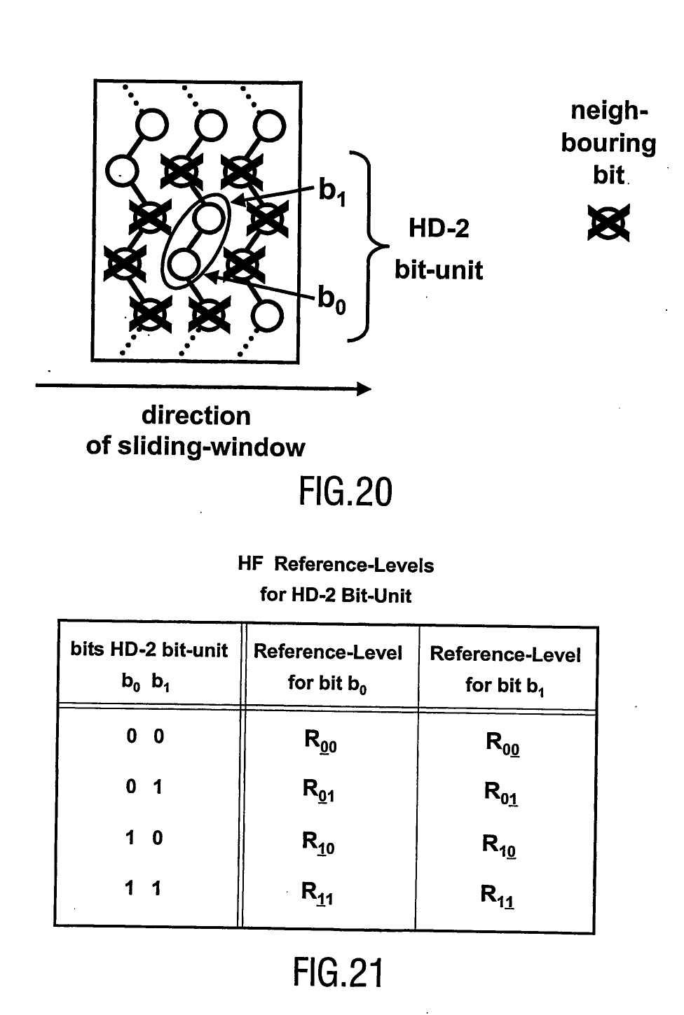

FIG. 20 shows a bit unit comprising two bits,

FIG. 21 shows the HF reference signal levels used in the bit detector shown in FIG. 17,

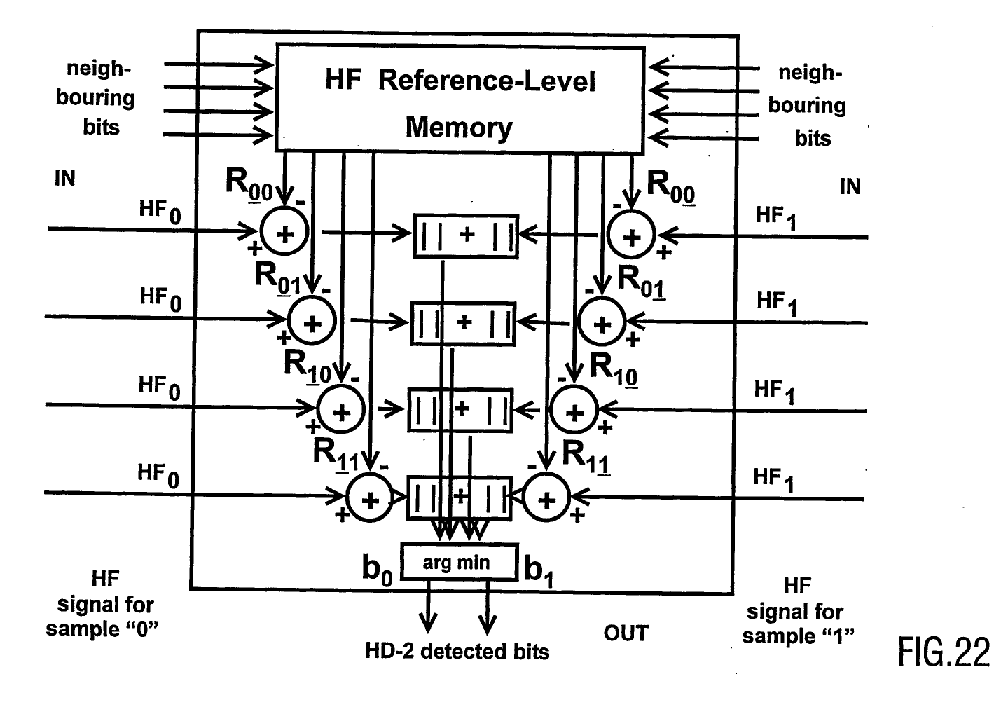

FIG. 22 shows a single bit detection unit of a bit detector shown in FIG. 17,

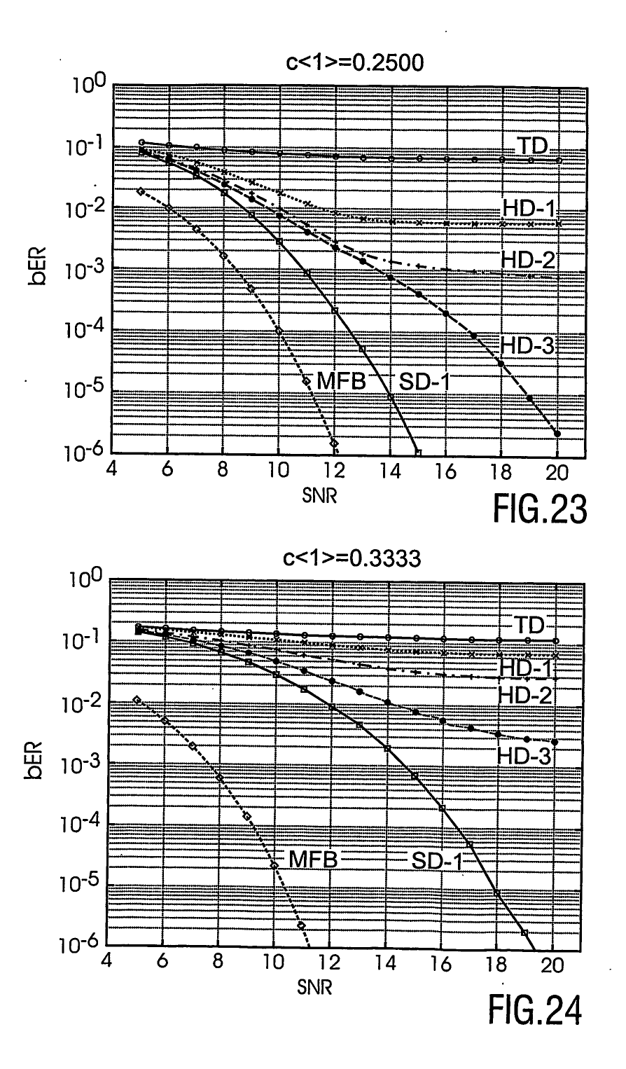

FIG. 23 shows the bit-error-rate as a function of SNR for a typical density and

FIG. 24 shows the bit-error-rate as a function of SNR for a second density.

FIG. 1 shows typical coding and signal processing elements of a data storage system. The cycle of user data from input DI to output DO can include interleaving 10, error-correction-code (ECC) and modulation encoding 20, 30, signal preprocessing 40, data storage on the recording medium 50, signal post-processing 60, binary detection 70, and decoding 80, 90 of the modulation code, and of the interleaved ECC. The ECC encoder 20 adds redundancy to the data in order to provide protection against errors from various noise sources. The ECC-encoded data are then passed on to a modulation encoder 30 which adapts the data to the channel, i.e. it manipulates the data into a form less likely to be corrupted by channel errors and more easily detected at the channel output. The modulated data are then input to a recording device, e.g. a spatial light modulator or the like, and stored in the recording medium 50. On the retrieving side, the reading device (e.g. photo-detector device or charge-coupled device (CCD)) returns pseudo-analog data values which must be transformed back into digital data (one bit per pixel for binary modulation schemes). The first step in this process is a post-processing step 60, called equalization, which attempts to undo distortions created in the recording process, still in the pseudo-analog domain. Then the array of pseudo-analog values is converted to an array of binary digital data via a bit detector 70. The array of digital data is then passed first to the modulation decoder 80, which performs the inverse operation to modulation encoding, and then to an ECC decoder 90.

In the above mentioned European patent application EP 01203878.2 the 2D constrained coding on hexagonal lattices in terms of nearest-neighbour clusters of channel bits is described. Therein, it has been focussed mainly on the constraints with their advantages in terms of more robust transmission over the channel, but not on the actual construction of such 2D codes. The latter topic is addressed in the European patent application 02076665.5 (PHNL 020368), i.e. the implementation and construction of such a 2D code is described therein. By way of example, a certain 2D hexagonal code shall be illustrated in the following. However, it should be noted that the general idea of the invention and all measures can be applied generally to any 2D code, in particular any 2D hexagonal or square lattice code. Finally, the general idea can also be applied to multi-dimensional codes, possibly with isotropic constraints, characterized by a one-dimensional evolution of the code.

As mentioned, in the following a 2D hexagonal code shall be considered. The bits on the 2D hexagonal lattice can be identified in terms of bit clusters. A hexagonal cluster consists of a bit at a central lattice site, surrounded by six nearest neighbours at the neighbouring lattice sites. The code evolves along a one-dimensional direction. A 2D strip consists of a number of 1D rows, stacked upon each other in a second direction orthogonal to the first direction. The principle of strip-based 2D coding is shown in FIG. 2. Between the strips a guard band of, for instance, one row may be located.

The signal-levels for 2D recording on hexagonal lattices are identified by a plot of amplitude values for the complete set of all hexagonal clusters possible. Use is further made of the isotropic assumption, that is, the channel impulse response is assumed to be circularly symmetric. This implies that, in order to characterize a 7-bit cluster, it only matters to identify the central bit, and the number of “1”-bits (or “0”-bits) among the nearest-neighbour bits (0, 1, . . . , 6 out of the 6 neighbours can be a “1”-bit). A “0”-bit is a land-bit in our notation. A typical “Signal-Pattern” is shown in FIG. 3. Assuming a broad-spiral consisting of 11 parallel bit rows, with a guard band of 1 (empty) bit row between successive broad spirals, the situation of FIG. 3 corresponds to a density increase with a factor of 1.7 compared to traditional 1D optical recording (as used in e.g. in the Blu-ray Disc (BD) format (using a blue laser diode).

At exactly the same density as traditional 1D optical recording (with the current BD standard taken as a yardstick), the signal-pattern of FIG. 4 is obtained. The signal waveforms of FIG. 4 are generated with a fully bi-linear scalar diffraction model that describes central-aperture (CA) diffraction-limited detection. Due to the bi-linear terms, which represent non-linear interferences between the bits due to the modulus-squaring operation in the physical detection at the plane of detection, 2D modulation has a characteristic problem of signal folding, that is, the signals of large land-areas and of large pit-areas are almost similar, which makes bit detection quite problematic. Therefore, an adapted write-strategy for the ROM write-channel has been proposed, in order to avoid signal folding: in a pit-bit, a small preferably circular pit-hole covering about 50% of the bit-area is to be realized via the write-channel. Assuming the read-channel of BD (λ=405 nm; NA=0.85), the lattice parameter of the hexagonal lattice amounts to 195.2 nm (with a pit-hole with radius b=60 nm for the pit-bits). The signal waveforms in FIG. 4 are not equalized (raw waveform). This situation corresponds with the same user capacity as for the BD system.

For a more simple analysis of the bit detectors, the channel is often approximated by a fully linear one with a 7-bit impulse response, and with a central tap denoted by c₀, and a nearest-neighbour tap (the same coefficient for all 6 nearest neighbour bits in the cluster) denoted by c₁. The schematic Signal-Pattern for this simplified model, together with that one for the “exact” scalar-diffraction model, is shown in FIG. 5. It applies for a density gain with a net factor of about 1.7 (compared to 1D-BD). FIG. 5 reveals the respective sizes of a user bit for 2D-modulation, and for BD (1D). The factor of 11/12 accounts for the presence of the guard band (of one empty row).

The situation of FIG. 5 corresponds with c₀=3 c₁ in the simpified abstracted channel model. It is to be noted that the four bottom signal levels of the clusters with a “0”-bit as central bit, have an overlap with the four top signal levels of the clusters with a “1”-bit as central bit. This overlap in signal levels is the basic problem of the “closed eye” for 2D optical storage at these more ambitious storage densities.

In FIG. 6 the Signal-Pattern for 2D modulation for a density gain with a net factor of almost 1.4× compared to 1D BD is shown. This situation corresponds with c₀=4 c₁ in the simplified channel model.

It shall be noted that, for the case of FIG. 6, the three bottom signal levels of the clusters with a “0”-bit as central bit, have an overlap with the three top signal levels of the clusters with a “1”-bit as central bit. This is again the basic problem of the “closed eye”. However, it is obvious that in this case, the situation is less dramatic than for the case of FIG. 5 with its four level overlap.

In FIG. 3, a general threshold level to be applied for all signal levels of the HF-signal has been drawn, which will lead to optimum bit-error rate for threshold detection. However, it is obvious that the signal levels of the two bottom clusters with the central bit equal to a “0”-bit, and the signal levels of the two top clusters with central bit equal to a “1”-bit, are at the wrong side of the threshold level, that is, threshold detection would lead obviously to erroneously detected (central) bits in these cases. These clusters are part of the so-called error-zone (or erasure-zone), as depicted in FIG. 3. The probability of occurrence of these clusters (with almost 100% probability of error) amounts to (1+6)/64, which is about 11%, leading to a bER of about 1.1 10⁻¹. Obviously, this bER is by far too high.

Firstly, reference will be made to a situation with an error-zone containing only two overlapping signal levels. This situation is shown schematically in FIG. 7. A bit with a signal value within the error-zone can be indicated as unreliable: such a bit has at maximum one neighbour of the same type. If the latter case applies (one neighbour bit of same type), then there are still three nearest neighbour bits that have at their turn at least two nearest neighbour bits of the same type. This implies that for these three bits, the signal value is outside of the error-zone, and all at the same side of the error-zone: these three neighbour bits can thus be detected with high reliability (because outside of the error-zone).

In other words, for a bit to have a signal level within the error-zone, it must have at least three neighbours with signal levels outside and at the same side of the error-zone. Thus, for a cluster with a signal amplitude within the error-zone, it is sufficient to determine the bit-value for the nearest neighbour bits to set the bit-value of a central bit. The step-by-step procedure for this case might be as follows:

first, threshold detection (with a single slicer level) is applied for the HF-signal at all bits;

then, all bits which have signal levels in the error-zone are identified as unreliable bits, the bit-value of which is not yet determined;

for each unreliable bit, the bit decisions of its nearest neighbour bits are checked; in the ideal case, there must be at minimum 3 nearest neighbours with signal levels outside the error-zone, and at the same side of the threshold level, that is, these nearest neighbour bits must be identical. In an erroneous situation, one or more of these nearest neighbour bits may also be within the error-zone. In such case, one should only check the reliable nearest neighbour bits.

the bit-value of the unreliable (central) bit is set to the opposite bit-value of its reliable nearest neighbour bits.

It is obvious that for the case, where the error-zone has three overlapping levels, the error-zone comprises also the clusters where a bit has exactly two nearest neighbours of the same type. Hence, there are situations in which all neighbours of a bit within the error-zone, are also within the error-zone: in such case, there are no reliable bits at all within the cluster of 7 bits, and the above procedure cannot be applied for all cases.

From the above discussion, it is clear that taking account of the bit decisions in nearest-neighbouring bits may be very beneficial in order to improve the reliability of the bit decisions. This is a joint bit detection approach. This basic principle will be used in the iterative bit detector of the present invention.

First, the bit detector where we aim to detect a single bit in a cluster of 7-bits—actually, the central bit of the hexagonal cluster—shall be described. The detector shall be denoted by HD-1. FIG. 8 illustrates the basic principle of the detector. Bits are updated in successive iterations, and for the first iteration, threshold decisions obtained with a single slicer level, as described in step one of the above simple procedure for two-level overlap are used.

FIG. 9 shows the configuration of the bits in the hexagonal cluster. The central bit is the one to be determined. Its neighbouring bits (indicated in yellow) have been detected in a previous iteration, and this information is used to detect the central bit. This is shown in FIG. 10. Assuming that the previous iteration has yielded two “1”-bits in the 6 nearest-neighbour bits of the central bit under consideration. Given these detected nearest neighbour bits, there are only two possible reference levels to which the detected HF-signal amplitude (denoted by x in FIG. 10) should be compared for the actual bit decision of the central bit. These two reference levels are denoted by T₀ and T₁ dependent on whether the central bit is a “0”-bit or a “1”-bit. The actual bit decision for the central bit is now realized by applying threshold detection, with the threshold at the half-way level (T₀+T₁)/2.

The detector HD-1 can be generalized to a detector in which a number of contiguous bits (defined as a bit unit) are detected at once, just by performing a maximum-likelihood evaluation of all possible candidate bit-patterns for the set of contiguous bits. By a set of contiguous bits we mean a set of bits that fill a contiguous two-dimensional area in the broad spiral. In FIG. 11, the respective areas of contiguous bits for the case of the detectors denoted by HD-1, HD-2 and HD-3 are shown. These detectors use respectively a single bit, or a doublet of bits (e.g. horizontally aligned), or a triplet of bits as a bit unit (or n=3-bit core) that is to be detected.

FIG. 11 reveals the different configurations of the surrounding bits (with bit-values detected in the previous iteration) and the bit-cores (the bits to be detected in the current iteration) for the three detectors listed (HD-1, HD-2 and HD-3). The number of bits in the core or bit unit amounts to 1, 2 and 3, respectively, and the number of bits in the configuration of surrounding bits amounts to 6, 8 and 9.

It may be clear that further generalizations to bit units of n bits can easily be made (yielding a HD-n bit detector).

In the following the HD-3 bit detector, where the bit unit or core consists of a bit-triplet, shall be considered more in detail, There are thus 2³=8 possible settings or possible bit-patterns of the bit unit. Evaluation of the best setting of the bit unit can be achieved by searching for the setting with the minimum value of a predetermined criterion. One possible criterion could be the sum of three terms (one term for each bit of the three bits of the bit unit), with each term being the squared difference between the detected (or received) HF-signal and the reference HF-signal that corresponds with the 7-bit hexagonal cluster that is constituted partly by the bits in the surrounding (denoted as “configuration” in FIG. 11), and partly by the bits in the bit unit (or “core” as denoted in FIG. 11).

The unravelling operation to identify the three separate hexagonal clusters is shown schematically in FIG. 12. The bits in the bit unit or core are denoted by {x₀, x₁, x₂}. For each of the core-bits, the corresponding hexagonal clusters are considered, denoted by {cl₀, cl₁, Cl₂}. The criterion suggested above is then:

$${S}^{2} = {\sum }_{i = 0}^{2} {( {HF}_{i} - RL [ {cl}_{i} ] )}^{2}$$

where HFᵢ denotes the signal waveform for the i-th bit of the bit unit, that is, xᵢ, and RL(clᵢ) denotes the reference amplitude level for a 7-bit hexagonal cluster of type clᵢ. So a total of 8 sums (each consisting of 3 terms), one for each of the possible settings or patterns of the considered bit unit, must be performed. The bit setting or bit pattern of the bit unit (of 3 core bits) yielding the lowest value for the sum will be selected as the outcome of the current iteration of the bit detector.

There are generally different implementations of the bit detector possible, such as a parallel and a sequential implementation. First, the sequential implementation shall be considered.

FIG. 13a shows the “sliding window” sequential implementation, which will be explained in more detail for the HD-1 bit detector. In particular, two subsequent stages of the sliding window are shown. The zig-zag pattern at the right-hand side is the most recent one, and its bit values are derived from a simple preliminary bit detector like a threshold detector. The zig-zag pattern at the left hand side is the oldest pattern, and its bit decisions have gone through 6 successive iterations of the HD-1 bit detector. Those bit decisions are the most reliable ones. Conceptually, the array of spots that is used for the parallel read-out of the information on the medium (disc) is scanning the right most zig-zag pattern in the window.

The sliding window consists of a part of the broad spiral consisting of n+1 zig-zag bit-arrays over the full width of the broad spiral. The bits are updated successively, in the order as indicated by the numbers in the bits as shown in FIG. 13b. The update procedure starts at the boundaries of the spiral, where the bit decisions have a higher reliability because of the known neighbouring land-bits (“0”-bits) of the guard band between two successive broad spirals. Once a bit has been updated, its updated value will be used when it is part of the set of neighbouring bits of one of the next bits that are to be updated. However, only the bits 1-2-3-4 and the bits 5-6-7 in each zig-zag can be processed independently; the next zig-zag again depends on the outcome of bit detection in the current zig-zag. The bit detector has thus become of the recursive type.

At the first zig-zag pattern, the detector starts with threshold detection (iteration j=0). At the second zig-zag, the detector performs iteration j=1, with at the neighbouring zigzag at its right side using bit decisions from j=0, and at the neighbouring zigzag at its left side using bit decisions from j=2. This procedure is continued until it reaches the last zig-zag in the sliding window.

Once all the bits are updated within the sliding window, the window shifts along the direction of the spiral over the distance of one zig-zag bit-array: this is shown in the bottom part of FIGS. 13a,b. For that new position of the sliding window, the procedure is repeated again.

FIG. 14 shows the signal processing hardware for a detector with 3 (or 4 if the threshold detection is counted as a first iteration; it can also be considered as an initialization step, just a matter of nomenclature) iterations of the HD-1 bit detector. The incoming HF-signals for all bit rows are represented by a HF-vector, comprising one (bit-synchronous) HF sample for each row within the meta-spiral. They result from A/D conversion of the analog signals generated by the photo-detector IC. The HF-vector is delayed for three subsequent stages. The bottom part of the figure represents the iterations on the bit-vectors (where a bit-vector comprises one bit for each row of the meta-spiral). A number of HD-1 detector-units (with the number equal to the number of rows in the meta-spiral) computes the updated bit-values according to the HD-1 algorithm. The last updated bit-vector is kept in memory for one extra stage, because the bit-values are needed as neighbouring bits in some of the “previous” stages to be carried out at the edges of the sliding window. The basics of the HD-1 bit detector unit are shown in FIG. 15. Into the detector unit 6 nearest neighbouring bits of the hexagonal lattice and the HF-sample of the bit that needs to be updated are inputted. The updated bit-value is outputted (denoted as “HD-1 detected bit” in FIG. 15). The neighbouring bits determine a threshold level, to be obtained from the corresponding “HF-Threshold Memory”. The HF-signal is sliced relative to this specific threshold level, and the output is the updated bit, or the “HD-1 detected bit”. The threshold level is obtained as the average signal level of a first reference level for the 7-bit hexagonal cluster consisting of the central 0-bit, surrounded by the given six nearest neighbour bits, and of a second reference level for the 7-bit hexagonal cluster consisting of the central 1-bit, surrounded by the same given six nearest neighbour bits.

FIG. 16 shows the connections for only two of the HD-1 bit detector units (for the sake of simplicity of this drawing). For the first case, where the bit to be updated is located at the edges of a zig-zag pointing towards the left side in FIG. 16, the HD-1 unit receives two neighbouring bits from the same bit-vector (upper and lower bits of the bit to be updated), three neighbouring bits from the bit-vector at the left, and one neighbouring bit of the bit-vector at the right. The HD-1 unit further receives the HF-signal from the corresponding HF-vector (upper half of the scheme), i.e., the HF-sample at the same location as the bit that needs to be updated. The output of the HD-1 unit goes into the bit value of the updated array of bits at the location of the bit to be updated, i.e. into the bit value of the bit at the right, hereby indicating that the output bit resides in the indicated location of the vector at the next clock cycle. The parallel operation of all HD-1 detectors between two successive vectors is here assumed to be handled within one clock cycle. All HD-1 units run in parallel between one bit-vector and the next bit-vector independently one from the other.

For the second case, where the bit to be updated is located at the edges of a zig-zag pointing towards the right side in FIG. 16, the HD-1 unit receives only one neighbouring bit from the bit-vector at the left, and three neighbouring bits from the bit-vector at the right; the remainder of the procedure is identical to the one mentioned above.

The HD-2 bit detector (simple implementation) with same structure as for HD-1 bit detector is shown in FIG. 17. This graph only applies under the assumption that all operations of the HD-2 bit detector can be performed within one clock-cycle.

In the case the HD-2 bit detector unit requires more than one clock cycle (which is highly likely, because of the relative complexity of the operations for finding the “best” candidate bit-pair for the bit-unit), then a parallel hardware implementation should be aimed at.

FIG. 18 shows the connections for only one of the HD-2 bit detector units (for the sake of simplicity of this drawing). For the first case, the HD-2 unit receives two neighbouring bits from the same bit-vector (upper and lower bits of the two-bit bit-unit to be updated), three neighbouring bits from the bit-vector at the left, and three neighbouring bits of the bit-vector at the right. The HD-2 unit further receives the HF-signals from the corresponding HF-vector (upper half of the scheme), i.e., the HF-samples at the same locations as the two bits of the bit-unit that needs to be updated. The output of the HD-2 unit goes into the bit values of the updated array of bits (at the right), at the locations of the two bits to be updated. All HD-2 units runs in parallel (between one bit-vector and the next bit-vector) independently one from the other.

A parallel implementation of the HD-2 bit detector, assuming that three clock cycles are needed for the HD-2 bit detector, is shown in FIG. 19. On the left-hand side, a buffer (implemented via a shift register) is filled in three consecutive clock-cycles (identical to the number of clock cycles required for the execution of one HD-2 bit detector block). That buffer is emptied at every third clock cycle, with each of the three HF-vectors feeding one of the three processing branches. In each processing branch, a number of HD-2 bit detector units (for the whole HF-vector array at once) is cascaded (to be seen as a number of sequential iterations on a given HF-vector array).

Each of the HD-2 blocks receives at its input the bit-arrays of neighbouring HF-vector arrays and the required HF-samples of the bits to be updated (not shown here for simplicity); the output of each of the HD-2 blocks is an updated bit-array.

It should be noted that neighbouring HF-vector arrays are meandering from top to bottom all the time. That is the reason why the respective bit-array inputs for the HD-2 blocks may cross from one branch to the other. Further, it should be noted that the appropriate neighbour-array for a block in the first branch is to be taken from the third branch, but at the previous update for that branch: hence the large arrow points upwards from right to left.

A HD-2 bit-uit with bits b₀ and b₁ is shown in FIG. 20. Therein, also the 8 neighbouring bits are indicated by crosses.

Reference-levels to be used in core of HD-2 bit detector are shown in FIG. 21. For bit b₀, the reference levels are denoted with the first sub-script underlined; for bit b₁, the reference levels are denoted with the second sub-script underlined. It should be noted that the 6 neighbours of the hexagonal bit-cluster around b₀ are determined by 5 neighbours already detected earlier (in a previous iteration), and by the other bit (bit b₁) of the two-bit bit-unit of the HD-2 bit detector. A similar argument holds for the hexagonal bit cluster around bit b₁.

The basics of the HD-2 bit detector block are shown in FIG. 22. 8 nearest neighbouring bits on the hexagonal lattice and HF-samples of the two bits of the bit-unit that needs to be updated are inputted. The two updated bit-values, i.e. HD-2 detected bits, are outputted (denoted as “HD-2 detected bits” in FIG. 22).

For each hexagonal cluster (with one central bit, and 6 neighbouring bits), a reference signal level is available from a memory (“HF Reference-Level Memory”). The reference level to be taken from the memory is determined by the two bits of the bit unit, and by 5 out of the 8 neighbouring bits of the two-bit bit-unit. The received HF-signal for each bit of the two bits of the bit-unit are subtracted from the corresponding reference level; the absolute values (shown here; it may also be any other “norm” like the quadratic norm using the squared values instead) of these respective signal differences are added together for each of the four possible two-bit configurations for the two bits of the bit-unit. The bits that result from the HD-2 bit detector are those that lead to the smallest value of the above set of 4 parameters (or samples of the selection criterion, one sample for each possible two-bit bit-unit). This is denoted in FIG. 22 in short-hand notation by “arg min”: the arguments (bits b₀ and b₁) for which the criterion is at the minimum. The performance of the iterative bit detector in its parallel implementation has been evaluated. The simplified (linear) channel with the 7-taps circularly symmetric impulse response has been assumed, with the conditions of c₀=4 c₁ of FIG. 6, and of c₀=3 c₁ in FIG. 5, respectively. As a channel disturbance, additive white gaussian noise (AWGN) has been assumed in order to evaluate the bit detectors.

FIG. 23 shows the results for about 1.4× BD density, with c₀=4 c₁, and FIG. 24 shows the results for about 1.7× BD density, with c₀=3 c₁. Apart from the threshold detector (TD), and the hard-decision bit detectors (HD-1, HD-2, HD-3), the result for the matched filter bound (MFB) for the case of single-bit errors and the result for a soft-decision bit detector have been included. It should be noted that for the regime of FIG. 24, with c₀=3 c₁, the single-bit errors are not the dominant error-pattern any more, which explains the relatively wide gap between MFB (computed for single-bit errors) and the other detectors. It would be better to compare here with the MFB computed for double-bit errors. In the latter regime, double bit-errors are the dominant ones, consisting of “+−” error patterns along one of the (by symmetry equivalent) axes of the hexagonal bit-pattern.

For the density of about 1.4× BD, it can be observed from FIG. 23 the successive improvements in bER going from TD over HD-1, HD-2 towards HD-3. HD-3 is markedly better than HD-1 and HD-2, which reveal a clear limit in their performance, due to the amount of overlap in the signal levels of the signal pattern. HD-3 has a larger degree of freedom in searching for the optimum pattern of bits, which clearly leads to the better performance. The soft-decision bit detector is again 4 dB better at a bER of 10⁻⁴.

For the density of about 1.7× BD, it can be observed from FIG. 24 a similar relative improvement going from TD, over HD-1, over HD-2 towards HD-3, but in this case, there is also a noticeable saturation in performance for the HD-3 bit detector, which can reach only a bER of 2 10⁻³. So, at this capacity, a hard-decision bit detector does not seem to be satisfactory. On the other hand, a soft-decision bit detector (denoted by “SD-1” in FIGS. 23 and 24) yields a much better performance.

In the above description the iterative hard-decision bit detectors for the case of 2D hexagonal modulation have been devised, where each bit has 6 nearest neighbours. It can equally well be applied for the case of 2D square-lattice modulation, where each bit has 4 nearest neighbours. Further, the present invention has been described for reference levels based on hexagonal clusters consisting of 7 bits: it is evident for a person skilled in the art that the present invention may be extended to the situation where the reference levels depend on clusters of a larger size, taking neighbouring bits into account beyond the nearest neighbouring bits on the 2D lattice of bits. Still further, this principle can also be applied in 1D modulation for optical storage. Then, the clusters of nearest neighbours are to be replaced by 1D bit-configurations with a length determined by the extent of the 1D impulse response of the channel.

Still further, after completing the last iteration, the HD-n bit detectors can yield soft-decision output, which can be used at a further stage in a LDPC decoder (or Turbo-decoder). Since the configuration of the nearest neighbours is fixed at each bit decision, the soft-decision information can be computed from the measured HF-signal for the bit under consideration, using the two cluster reference levels T₀ and T₁ (which are the reference levels with the central bit being a “0” or a “1”, respectively). The soft-decision information is then the probability that the bit has a value “1”, and can be obtained from a Fermi-Dirac like S-curve, based on the two reference levels.

1. Bit detection method for detecting the bit values of bits of a channel data stream stored on a record carrier, wherein the channel data stream resides on an N-dimensional lattice of bits and comprises a plurality of contiguous bit units, each bit unit comprising at least one bit, wherein bit detection for the channel data stream is performed by an iterative procedure, each iteration being carried out on the basis of said bit units, wherein the bit values of the bits of said bit units are detected by said iterative procedure based on the received HF signal values of the bits of said bit units, said method comprising:
an initialisation step to obtain preliminary bit decisions for the bits of said bit units based on the HF signal values of said bits,
an updating step to update the bit values of the bits of said bit unit to be updated by searching for the bit values of each of the bits in said bit unit to be updated that best fulfil a predetermined criterion for said bit unit to be updated, said criterion being determined by the differences of the HF signal value and a reference HF signal value for each single bit of said bit unit to be updated, wherein said reference HF signal value is determined by the bit value of said single bit in said bit unit to be updated and by the bit values of the neighbouring bits of said single bit, and
an iteration to iterate said updating step until a predetermined condition is fulfilled.

2. Method as claimed in claim 1,
wherein the bit values of said neighbouring bits, which are not part of said bit unit to be updated, are determined in a previous updating step of the iterative procedure, preferably the preceding updating step, and
wherein the bit values of the neighbouring bits, which are part of said bit unit to be updated, are set to be equal to the corresponding bit values of each of the possible bit patterns that can be set up for said bit unit to be updated.

3. Method as claimed in claim 1,
wherein said preliminary bit decisions of said initialisation step are obtained by threshold detection using a slicer level.

4. Method as claimed in claim 1,
wherein said predetermined criterion to be fulfilled by a bit unit is determined by the sum over all the bits in said bit unit, said sum comprising the squared differences of the HF signal value and a reference HF signal value for each single bit of said bit unit.

5. Method as claimed in claim 1,
wherein said predetermined criterion to be fulfilled by a bit unit is determined by the sum over all the bits in said bit unit, said sum comprising the absolute values of the differences of the HF signal value and a reference HF signal value for each single bit of said bit unit.

6. Method as claimed in claim 1,
wherein said channel data stream comprises a one-dimensionally evolving bit sequence.

7. Method as claimed in claim 1,
wherein N is 3 yielding a three-dimensional lattice of bits.

8. Method as claimed in claim 1,
wherein N is 2 and said channel data stream comprises a channel strip of at least two bit rows one-dimensionally evolving along a first direction and aligned with each other along a second direction, said two directions constituting a two-dimensional lattice of bit positions.

9. Method as claimed in claim 6,
wherein said bit unit comprises one bit and wherein said reference HF signal value is determined by said one bit and its neighbouring bits, said neighbouring bits being determined in a previous updating step of the iterative procedure.

10. Method as claimed in claim 9,
wherein the bit value of the single bit of said bit unit is updated by a threshold operation using a slicer level set at half of the sum of a first reference HF-signal for the case said single bit would have bit value 0 and a second reference HF-signal for the case said single bit would have bit value 1.

11. Method as claimed in claim 8,
wherein the bits of said channel data stream are arranged on a two-dimensional hexagonal or square lattice.

12. Method as claimed in claim 8,
wherein said bit unit comprises two or three bits and wherein said reference HF signal value for each of said two or three bits is determined by said two or three bits and its respective neighbouring bits.

13. Method as claimed in claim 8,
wherein said channel strip comprises at least three bit rows and wherein in said initialization step said preliminary bit decisions for the bits of said bit unit are obtained by threshold detection, said threshold detection being performed in a predetermined sequence within a bit column comprising at least one bit of each bit row and being aligned in said second direction, wherein the outermost bits of said bit column are threshold detected first and the other bits of said bit column are threshold detected subsequently.

14. Method as claimed in claim 13,
wherein in said updating step of the iteration the bit values of the bits of said bit units to be updated are updated subsequently bit column by bit column for a number of bit columns defining a detection window, wherein the bit values of the bits of each bit column are updated in the same sequence as they have been threshold detected in said initialisation step.

15. Method as claimed in claim 13,
wherein in said updating step of the iteration the bit values of the bits of said bit units to be updated are updated in parallel for a number of bit columns.

16. Method as claimed in claim 1,
wherein at any possible step in the iterative procedure, additional to the bit decisions, reliability or soft-decision information is generated for the detected bits, said reliability or soft-decision information determining the probability that a bit has the binary value “0” or “1”.

17. Bit detector for detecting the bit values of bits of a channel data stream stored on a record carrier, wherein the channel data stream resides on an N-dimensional lattice of bits and comprises a plurality of contiguous bit units, each bit unit comprising at least one bit, wherein bit detection for the channel data stream is performed by an iterative procedure, each iteration being carried out on the basis of said bit units, wherein the bit values of the bits of said bit units are detected by said iterative procedure based on the received HF signal values of the bits of said bit units, said bit detector comprising:
an initialisation means for obtaining preliminary bit decisions for the bits of said bit unit based on the HF signal values of said bits,
an updating means for updating the bit values of the bits of said update bit unit by searching for the bit values of each of the bits in said update bit unit that best fulfil a predetermined criterion for said update bit unit, said criterion being determined by the differences of the HF signal value and a reference HF signal value for each single bit of said update bit unit, wherein said reference HF signal value is determined by the bit values of said single bit in said update bit unit and by the bit values of the neighbouring bits of said single bit, and
an iteration means for iterating said updating of said bit values until a predetermined condition is fulfilled.

18. Bit detector as claimed in claim 17, further comprising
a first array of registers for storing subsequent HF-vectors comprising HF signal values for bits of different bit rows, and
a second array of registers for storing the bit-vectors comprising bit values for bits of different bit rows,
wherein the bit detector unit is arranged between two subsequent registers of said second array, receiving as inputs the neighbouring bits obtained from the array of bit-vectors and the proper HF signal value obtained from the array of HF-vectors and outputting the updated bit value, and wherein the updated bit-value is stored in a subsequent register of said second array.

19. Bit detector as claimed in claim 18,
wherein said first array of registers is adapted for storing the HF-vectors in a register at each instant of the bit-clock and for transferring them at every M-th clock further to a set of registers of said second array.

20. Method of reproduction of a user data stream, which is error correction code encoded and modulation code encoded into a channel data stream and stored on a record carrier, comprising a bit detection method as claimed in claim 1 for detecting the bit values of bits of said channel data stream and a modulation code decoding method and an error correction code decoding method.

21. Reproduction device for reproduction of a user data stream, which is error correction code encoded and modulation code encoded into a channel data stream and stored on a record carrier, comprising a bit detector as claimed in claim 17 for detecting the bit values of bits of said channel data stream and a modulation code decoder and an error correction code decoder.

22. Computer program comprising program code means for causing a computer to perform the steps of the methods as claimed in claim 1 when said computer program is executed on a computer.
